(19) United States
(12) Patent Application Publication
(10) Pub. No.: US 2014/0111129 A1
(43) Pub. Date: Apr. 24, 2014

(54) UNIT COMPRISING AN ELECTRIC POWER SOURCE INCLUDING AT LEAST TWO ELEMENTS OF DIFFERENT TECHNOLOGIES AND AN INVERTER FOR CONTROLLING AN ALTERNATING-CURRENT ELECTRIC MOTOR

(71) Applicant: Ivan Modolo, Clermont-Ferrand Cedex 9 (FR)

(72) Inventor: Ivan Modolo, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/116,162

(22) PCT Filed: May 9, 2012
(86) PCT No.: PCT/EP2012/058544

§ 371 Date: Dec. 18, 2013

(30) Foreign Application Priority Data
May 13, 2011 (FR) 1154182

(51) Int. Cl. H02P 6/00

(52) U.S. Cl. CPC H02P 6/002
USPC 318/400.22

(57) ABSTRACT

An installation for an electric motor includes an electrical energy source with elements of different technologies and an inverter for controlling an AC electric motor. The inverter includes an AC current generator for delivering current to a terminal strip to be connected to phases of the electric motor, a supply line, current sensors on certain phases supplying the electric motor, a current sensor on the supply line, an input for receiving information that includes a limit current of the source and a requested-torque setpoint, and a controller for controlling phase currents of the electric motor as a function of the setpoint while maintaining a current of the supply line at an acceptable value as a function of the limit current of the source. The installation makes it possible to impose a maximum current on the current generator without risk of impairing the current generator.

### FIELD OF THE INVENTION

The present invention pertains to the control of electric motors. More particularly, it pertains to the control of the electric motors used especially for vehicle traction.

### PRIOR ART

It is known that such a motor comprises, at the stator, a magnetic circuit and electrically conducting wire coils capable of producing a stator magnetic flux. In the case of a synchronous motor, at the rotor, the motor comprises permanent magnets and a magnetic circuit producing a rotor magnetic flux. In the case of an asynchronous motor, the motor comprises a squirrel cage rotor. In the case of a reluctant motor, the motor comprises a reluctant rotor. In many applications for electric vehicles, synchronous motors are used. Such a motor is equipped with a “resolver” giving the position of the rotor with respect to the stator. Such a motor is always associated with an inverter to ensure the control thereof

The person skilled in the art knows that, in practice, electric motors are reversible machines, that is to say they also operate as an alternator. This is why it is also usual to speak of electric machines. When speaking hereinbelow of motor, this is for linguistic convenience, it being understood that the context of the present invention covers in general an electric machine, whether it is operating as a motor or as an alternator.

In very numerous applications, especially to automotive vehicles, the electrical energy source is a DC source such as a battery or a fuel cell. In this case, the inverter for controlling the motor comprises an inverter transforming the DC signal into an AC signal whose amplitude and frequency are suited to the operating setpoints of the motor. The role of the three-phase inverter associated with a motor is to generate a desired mechanical torque at the motor shaft output on the basis of a DC supply.

By way of illustration of the prior art may be cited patent application US 2003/0088343 which describes an electric traction chain for hybrid automotive vehicle equipped with an internal combustion engine and with an electric motor which intervenes as assistance for the motorization of the vehicle. The electric motor is itself supplied by a battery. As regards the control of the motor, this document describes a principle based on limitation of the torque as a function of the limit power of the battery. Reference is made to a maximum discharge power. Also described is the use of a battery current sensor used to command the discharge power, as well as a battery temperature sensor making it possible to determine a limit power of the battery as a function of a pre-established mapping of the power as a function of temperature. This arrangement does not allow very dynamic regulation.

In the field of vehicles with purely electric traction may be cited the U.S. Pat. No. 5,600,125 which describes a controller for battery electric vehicle. This patent effects regulation of the torque of the electric motor as a function of the battery voltage. But this principle does not allow good command of the current in the case of certain types of battery, such as Li-Ion batteries, for example, whose use is tending to spread. The voltage of Li-ion batteries indeed depends on numerous factors (temperature, state of charge, aging) and it is very problematic to correctly regulate a discharge current in this manner. Furthermore, in the description of this document, the limit voltage of the battery is a predefined fixed value, not updated as a function of the evolution of the state of charge, of the temperature, etc, hence fairly coarse regulation.

In most applications requiring significant powers, three-phase machines are used. The operating principle is as follows: the interaction between the stator magnetic field of the motor, created by the current in the coil, and the rotor magnetic field, produces a mechanical torque. On the basis of the DC voltage of the supply, the inverter, by virtue of three branches of power transistors, produces a system of three-phase currents of appropriate amplitude, appropriate frequency and appropriate phase with respect to the rotor field, so as to supply the three phases of the motor. In order to check the amplitude of the currents, the inverter has current sensors making it possible to ascertain the currents of each phase of the motor. To check the frequency and the phase of the currents, the inverter receives the signals from a resolver which measures the position of the rotor with respect to the stator.

The general controller is equipped with a modelling of the motor which makes it possible to exactly ascertain the phase currents to be produced to obtain the desired motor torque. The inverter, on the basis of the modelling of the motor, determines the setpoints of the phase currents of the motor and produces them by virtue of its regulators. The inverter does not therefore servocontrol the torque, but the current of the motor. As a function of the various operating conditions (temperature of the motor, temperature of the inverter, length of the cables) and of manufacturing spread of the inverters and motors, for a given motor current, the losses of the motor, of the inverter and of the cables can vary. Consequently, the power, and therefore the current absorbed on the source, may differ from one case to another.

Consequently, it is necessary to model the losses of an inverter-motor system chosen as gauge, the modelling being performed at a given temperature. The temperature is in general chosen to be rather high so as to overestimate the motor losses, these being out of all the losses, those which are the most dependent on temperature. In this manner, for a given torque setpoint, the current to be drawn off from the current source is overestimated in order to guarantee that the current does not exceed the current acceptable by the source.

Another example of regulation based on modelling can be consulted in patent application EP 1410942. The latter also describes a controller for battery electric vehicle. In particular, it describes a limitation of the consumption of the current of the source by way of motor control, the said limitation being based on a modelling of the motor, that is to say the establishment of a mapping of the motor as a function of various parameters.

This approach is not optimal because it is difficult to perform a modelling that is sufficiently representative of all elements in all cases of use. In practice, modellings are carried out on the laboratory test bench and not on the vehicle or, even if followed by modelling on the vehicle, not all cases of use of the latter are investigated, to say nothing of taking account of the aging of the components in the modelling.

This approach (modelling) therefore leads to the full power of the source not being used in cases where the real losses are lower than those estimated (low temperature for example) and it does not take account of the aging and therefore of the loss of efficiency of the inverter or of the motor. Thus, maximum performance is not guaranteed under all conditions.

The objective of the invention is to circumvent the need to model the losses and to propose the means for better control of the motor.

### BRIEF DESCRIPTION OF THE INVENTION

The invention proposes an installation comprising an electrical energy source comprising at least two elements of different technologies and an inverter for controlling an electric motor, the motor comprising a stator having at least two phases and a rotor, the said inverter comprising:
two terminals for attachment to a DC bus associated with a DC electric voltage and DC electrical energy source,
an AC current generator delivering a current to a terminal strip intended to be connected to the phases of the said electric motor,
a supply line between the attachment terminals and the generator,
a supply current measurement line on which there flows a measurement of the current on the supply line,
at least one motor current measurement line on which there flows a measurement of the AC current on certain phases supplying the said electric motor so as to ascertain the AC current flowing in each of the phases,
an input receiving information comprising at least one value of “limit current of the source” for the current flowing on the supply line, the said limit current of the source globally considering the said at least two elements of different technologies, and comprising a requested-torque setpoint (Ccons),
a controller receiving the measurements of current on the supply line, the measurements of the current of phases of the electric motor, the limit currents of the source (Idc max and Idcₘᵢₙ), the requested-torque setpoint (C CAN), the controller making it possible to control the phase currents of the electric motor as a function of the requested-torque setpoint and while maintaining the current passing through the supply line at a value compatible with the limits of the source.

In a particularly beneficial implementation when the invention is applied to the control of the traction motors of a vehicle, the “limit current of the source” comprises a maximum-current setpoint (of positive sign) corresponding to a current tapped off from the electrical energy source when the motor is operating in traction mode and a minimum-current setpoint (of negative sign) corresponding to a current returned on the DC bus, in general to recharge the electrical energy source, when the electric motor is operating in recuperative braking mode.

In the present document, “source” is intended to mean the set of the electrical means making it possible either to deliver, in traction mode, or to absorb, in electrical braking mode, a given power. The types of sources which may be present on the DC bus are three in number:
bidirectional sources, that is to say sources in which the electric current can flow in both directions and which are therefore capable of delivering an electric current on the DC bus or of absorbing an electric current originating from the DC bus: batteries, super-capacitors, or even an electric machine coupled to an inertial wheel, etc.
unidirectional sources, and among the latter:
   pure electrical supply sources, capable only of delivering an electric current on the DC bus: fuel cells, alternator driven by a heat engine (neglecting the motor brake of a heat engine), etc.
   pure dissipaters capable only of absorbing an electric current originating from the DC bus: dissipation resistors, etc.

The invention pertaining to an installation comprising an electrical energy source comprising at least two elements of different technologies, it can apply to a bidirectional source coupled to a pure dissipater, or to a pure electrical supply source (fuel cell) coupled to a pure dissipater, or a bidirectional source coupled to a pure electrical supply source (fuel cell) or else the three categories combined, or else several elements of one and the same category but of different technologies.

For diverse optimization reasons which do not form part of the disclosure of the present invention, it may be desirable for sources of various technologies to be installed aboard a vehicle. For example, the source can comprise the association of several electrical elements capable of storing electrical energy (battery and super-capacitors for example). The source can also comprise an electrical accumulator and a dissipation resistor. Of course, the dispatching of recharge current to the battery and/or to the dissipation resistor has to be managed. In all cases, the management of the flow or of the steering of energy to or from elements of different technologies does not form part of the present invention.

The present invention not being concerned with the aspect of the management of two or more elements used to deliver electrical power and/or used to absorb electrical power, it will be agreed that, for the needs of the present invention, the “limit current of the source” must be considered globally, for the set of various elements of the source that are used in parallel, as an electrical accumulator and a dissipation resistor.

### BRIEF DESCRIPTION OF THE FIGURES

The subsequent description enables all the aspects of the invention to be clearly elucidated by means of the attached drawings in which:

FIG. 1 illustrates an inverter according to the invention;

FIG. 2 is a block diagram representing a specific processing of the inverter of the invention;

FIG. 3 is a block diagram of an additional device of the inverter of the invention

FIG. 4 illustrates a particular implementation of the invention with a bidirectional source (battery) coupled to a pure dissipater.

### DESCRIPTION OF BETTER EMBODIMENTS OF THE INVENTION

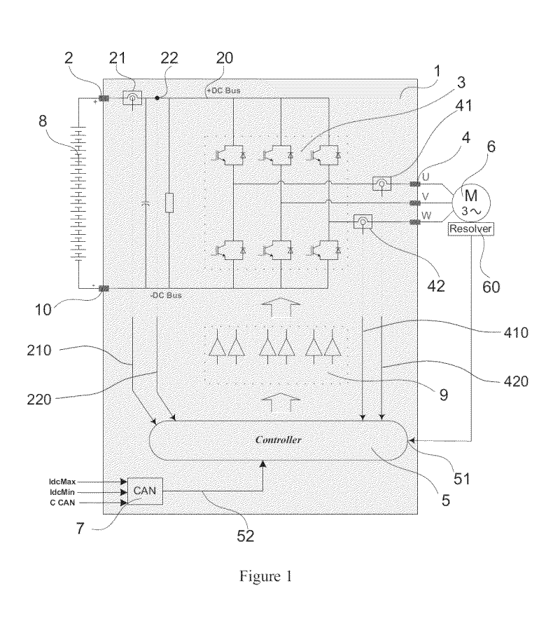

In FIG. 1 may be seen an inverter 1, a three-phase electric motor 6, a battery 8 constituting the DC electrical energy source and a CAN ® bus 7 on which there flows information used by the inverter 1. The three-phase electric motor comprises a stator having at least three phases U, V, W and a rotor.

The inverter 1 comprises two terminals 2 and 10 for attachment to a DC bus (direct current bus) associated with a DC electric voltage and DC electrical energy source. It comprises an AC current generator 3 delivering a current to a terminal strip 4 intended to be connected to the phases U, V and W of the said electric motor 6. The inverter 1 comprises a supply line 20 between the terminal 2 and the current generator 3. The inverter 1 comprises a controller 5 and a control stage 9 receiving control orders from the controller 5 and ensuring the control of the power transistors of the current generator 3.

In a preferred implementation of the invention, so as to allow control having excellent performance, the rotor of the electric motor 6 is a synchronous motor and is associated with a resolver 60 giving the relative position between rotor and stator. The inverter 1 then comprises an input 51 receiving the signal delivered by the said resolver. However, this arrangement is not limiting; the person skilled in the art knows that there exist algorithms which make it possible, on the basis of the measurements of phase currents and of voltages, to estimate the position of the rotor with respect to the stator.

It was seen in the introductory part of the present patent application that one of the essential characteristics of the present invention is to have a controller making it possible to control the phase currents of the electric motor as a function of the requested-torque setpoint and while maintaining the current passing through the supply line at a value compatible with the limits of the source. To this end, in the nonlimiting implementation described in the present document, the inverter further comprises a supply voltage measurement line 220 on which there flows a measurement of the voltage on the supply line 20, and the controller 5 furthermore receives the measurement of the voltage on the supply line 20. Indeed it turns out to be advantageous to implement, in the controller, a regulating law which uses the supply voltage in its parameters. The controller 5 also receives the signals of the resolver 60. On the basis of this information, the controller 5 determines a control torque (Cpil) of the electric motor so as to control the phase currents of the electric motor, in such a way that the said control torque (Cpil) is identical to the requested-torque setpoint (Ccons) as long as the current on the supply line 20 remains distant from the limit current of the source and, when the current on the supply line 20 reaches the limit current of the source, the said control torque (Cpil) is reduced with respect to the requested-torque setpoint (Ccons) so as not to exceed the limit current of the source on the supply line 20.

Very advantageously, several sensors are directly integrated into the inverter according to the invention. But, it must be understood that what is essential to the invention is not the integration of the sensors per se, but the fact that the signals that they deliver are used directly as parameters of the regulation performed by the inverter. Having spelled this out, the inverter integrates a sensor of current 21 on the supply line, the said current sensor 21 delivering its measurement on the said supply current measurement line 210. The inverter also integrates a sensor of voltage 22 of the supply line, the said voltage sensor 22 delivering its measurement on the said supply voltage measurement line (220). The inverter further integrates a resistor 23 of FIG. 1 attached between the positive pole +DCBus and the negative pole −DCBus of the supply line 20; this resistor, of very high value so as to absorb only negligible power, serves for the discharging of the capacitors of the inverter when turning off the vehicle, for safety reasons. The inverter further integrates an AC current sensor, more precisely two AC current current sensors 41, 42 installed on certain phases supplying the said synchronous electric motor 6, namely on the phases U and W, the current on the phase V being the sum of the phase U and phase W currents. These AC currents supply the synchronous electric motor 6. The said AC current sensors 41, 42 deliver their measurement on two (410, 420) of the said at least one motor current measurement lines.

The inverter 1 comprises a sensor of current 21 on the supply line 20, as well as a voltage sensor 22. The inverter 1 further comprises an input 52 receiving information flowing on the CAN® bus 7. Among this information, there is the limit current setpoint Idc max of the source (setpoint of positive sign) corresponding to a current tapped off from the electrical energy source when the motor is operating in traction mode and the minimum-current setpoint Idc min of the source (setpoint of negative sign) corresponding to a current returned to the electrical energy source when the electric motor is operating in recuperative braking mode. This is the most intense recharge current that the source can accept.

Let us stress that the current setpoints are themselves calculated continuously as a function of the state of the vehicle. When the current returned to the source can but be absorbed by the said source, it is a recharge current whose limit value depends on the state of charge of the source and its technology. For example, a lead battery allows only small recharge currents whereas a bank of super-capacitors allows high recharge currents, identical to the discharge currents. Lithium Polymer batteries or Lithium Ion batteries accept fairly substantial charge currents, but nevertheless lower than the discharge currents. To summarize, the determination of values of “limit current of the source” depends on the technology of electrical accumulator used, on the state of charge of the accumulator and on conditions of vehicles, all things which are outside of the framework of the present invention. The said values constitute input data that the present invention makes it possible to utilize in a clever manner.

The inverter 1 comprises a controller 5 which receives the signals of the voltage sensor 22 on the supply line 2, of the sensor of current 21 on the supply line 2, of the resolver 60, of the current of each phase of the synchronous electric motor by virtue of the sensors 41 and 42, the limit currents Idc max and Idc min of the battery 8, the requested-torque setpoint C CAN such as desired, also flowing on the CAN® bus 7.

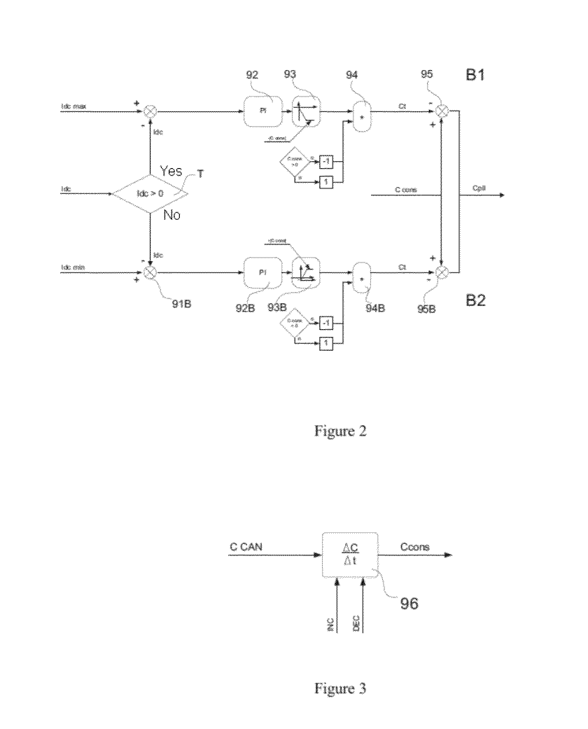

It is seen in FIG. 2 that the controller 5 comprises a bus current regulator acting on the torque setpoint Cpil, this regulator comprising a processing branch B1 receiving the maximum-current setpoint Idc max, a processing branch B2 receiving the minimum-current setpoint Idc min and a test module T making it possible to toggle between one or the other line according to the sign of the current.

The current travelling on the supply line 20 is measured by the current sensor 21 (see FIG. 1) which communicates the measurement Idc of the current to the test module T which, in its turn and according to the sign of the current, dispatches the measurement Idc on the branch B1 in the case of positive value, that is to say when the motor 6 is operating in traction mode, or on the branch B2 in the case of negative value, that is to say when operating in recuperative braking mode.

A measurement of the current of two of the three phases of the motor 6 is also performed by a sensor 41 on the phase U of the motor 6 and by a sensor 42 on the phase W of the motor 6. These values of current are communicated to the controller which calculates the current on the phase V.

Moreover, the controller transforms the requested-torque setpoint C CAN into a control torque setpoint Cpil of the motor 6 as will be explained hereinbelow and then transforms this control torque Cpil into a value of motor phase current in a conventional manner well known to the person skilled in the art.

Let us return to FIG. 2 and let us firstly consider the branch B1. This branch corresponds to operation in motor mode where the inverter consumes current on the source. Let us consider that the torque setpoint Ccons is identical to the requested-torque setpoint C CAN flowing on the CAN® bus. The control torque setpoint Ccons is positive (Ccons>0) in forward mode or it is negative (Ccons<0) when the driver of the vehicle has selected reverse mode. In passing, let us point out that the resolver 60 communicates an information item to the controller 5 which allows the latter to ascertain the speed of the vehicle, with its sign, therefore making it possible to ascertain the direction of travel of the vehicle. Hence, by comparison of the signs of the desired torque C CAN on the one hand and of the vehicle speed on the other hand, the controller 5 can determine whether it is operating in traction mode or in braking mode.

A summator 91 receives on the one hand the limit current setpoint Idc max of the source and on the other hand the current measurement Idc and delivers the deviation in current with respect to the value of limit current of the source. The said deviation is processed by a “Proportional Integral” regulator 92 and by a peak limiter 93 which limits the result after Proportional Integral regulator 92 to the value “minus the absolute value of the setpoint torque Ccons”. The result, optionally clipped by the peak limiter 93, thereafter passes through a “sign of the torque” module 94 which maintains the sign of the result or changes it, depending on whether the initial torque setpoint desired by the driver of the vehicle is a torque tending to increase the motion of travel of the vehicle forwards (positive sign) or to increase it backwards (reverse mode, negative sign) to obtain the result Ct. The result Ct enters a summator 95 which moreover receives the torque setpoint value Ccons and delivers a control torque setpoint Cpil to control the torque of the electric motor 6.

Thus, if in traction mode (positive setpoint torque, assumed close to the maximum torque for the purpose of argumentation, branch B1), if the current Idc max equals 100 A, if the measured current equals 105 A, beyond the limit, the summator 91 delivers a negative value −5 A, the amplitude of which is proportional to the overshoot, transformed into a deviation torque with value proportional to the overshoot and with “minus” sign by the Proportional Integral regulator 92. Thereafter, there is inversion of the sign of the deviation torque by the “sign of the torque” module 94 since we are in traction mode. After the summator 95, the deviation torque Ct is deducted from the setpoint torque Ccons to give a motor control torque Cpil reduced so as to take account of the overshoot in current allowable by the source. In all cases where the output of the Proportional Integral regulator 92 is a zero value, the output of the peak limiter 93 is a zero value, the output of the “sign of the torque” module 94 is a zero value and the control torque Cpil remains identical to the torque setpoint Ccons. If the current Idc is positive whereas the torque setpoint is negative (the vehicle is going in reverse and in motor operation), then the regulator increases the setpoint (that is to say makes it tend to 0) so as to decrease the consumption on the source.

The branch B2 corresponds to operation in recuperative braking mode where the inverter injects current on the source. The torque setpoint Ccons is positive (Ccons>0) in reverse mode or it is negative (Ccons<0) in forward mode. The operating principle is identical. In forward mode, the torque setpoint Ccons is below zero; this time the output of the Proportional Integral regulator 92B is positive; this time the “sign of the torque” module 94B inverts the sign when the torque setpoint is negative.

In all typical cases, the mechanism tends to reduce (in absolute value) the resulting torque setpoint termed the control torque with respect to the (original) torque setpoint.

The power consumed on the source for a given motor current varies as a function of a large number of parameters. Even if it were possible to model the influence of each parameter (temperature, length and type of cable, aging) on the losses, this work has to be repeated at least on each motor and on each electronics. Moreover all these modellings, have to be implanted in a central unit which must in real time calculate that the torque setpoint that it requests from the inverter does not bring about losses, therefore a power, and ultimately a current consumed on the source which is unacceptable to the latter. This is true when the inverter-motor system is consuming current, but it is also true when this system is a generator. In this second case, it is also necessary to verify that the current injected towards the source is acceptable. In contradistinction to the approach described hereinabove, the present invention makes it possible at any moment, independently of the level of losses in the controlled electric motor and in the inverter itself, without having to resort to a calibration, in a manner auto-adaptive to the drift of the components that may cause a variation of the said losses, to always be able to tap off the maximum allowable current from the source, or to inject into it the maximum recharge current that it allows without damaging the said DC current source. Hence, the overall power of the inverter-motor system, that is to say for example of the electric traction system installed on a vehicle, is optimized without having to adopt overly large safety coefficients in the dimensioning which would be prejudicial, at iso power, to the weight of the system, or at iso safety coefficient, while decreasing the risk of damage.

The fact of having added a measurement of the bus current now makes it possible to carry out within the inverter the command of this current. Indeed, an internal regulator modifies in real time the control of the motor so as to comply with a maximum current (consumed on the source) or minimum current (injected on the source) of the source.

The management of the system is thereby greatly simplified. There is no longer any need to ascertain the characteristics of the motor elements, inverter, cable. A central unit (not represented) of the vehicle dispatches via the CAN® bus 7 to the inverter two bus current setpoints: maximum bus current (Idc Max>0) and minimum bus current (Idc Min<0). The inverter 1 complies with the torque setpoint coming from a central unit of the vehicle as long as the bus current remains between the values Idc Min and Idc Max. When the bus current regulator operates so as not to exceed these limits, the torque setpoint is no longer complied with. In a manner advantageous for the overall management of the vehicle, the inverter 1 continuously dispatches (via the CAN® bus 7) the value of the torque actually generated to the central unit of the vehicle.

In an implementation of the invention which is particularly advantageous for ensuring apt operation of an automotive vehicle with electric traction, a processing of the requested-torque setpoint C CAN is added to the controller 5 so as to obtain a reprocessed control torque setpoint Ccons, this processing being illustrated in FIG. 3. In FIG. 3 it is seen that the controller comprises a “torque ramp” block 96 receiving as input the torque setpoint C CAN coming via the CAN® communication network 7 (see FIG. 1), receiving a state INC signifying that the increase in the torque is permitted, receiving a state DEC signifying that the decrease in the torque is permitted, and delivering the setpoint torque Ccons actually used in the processing illustrated by means of FIG. 2.

Under normal operation of the vehicle, that is to say when the current of Idc has not reached one of the limits, the outputs of the Proportional Integral regulator 92 and peak limiter 93 assembly and the Proportional Integral regulator 92B and peak limiter 93B assembly are zero values, which activate the state INC if C CAN>Ccons, or which activate the state DEC if C CAN<Ccons. In this case, as long as the requested-torque setpoint C CAN is above the control torque setpoint Ccons (C CAN>Ccons), then Ccons is incremented by ΔC/ΔT according to a chosen ramp and in the same manner, as long as the requested-torque setpoint C CAN is below the control torque setpoint Ccons (C CAN<Ccons), then Ccons is decremented by ΔC/ΔT according to a chosen ramp; This makes it possible to obtain very progressive operation of the vehicle although the variation of the requested-torque setpoint C CAN may be fierce, and above all it is transmitted as successive tiers because it is refreshed for example every 20 milli-seconds.

During throttled operation of the vehicle, that is to say when the current of Idc has reached one of the limits, one of the outputs of the Proportional Integral regulator 92 and peak limiter 93 assembly or of the Proportional Integral regulator 92B and the peak limiter 93B assembly is a different value from zero, thereby deactivating either the state INC or the state DEC depending on whether the inverter is consuming or generating energy and whether running in forward mode or in reverse mode. To summarize, there are four cases:
i) forward mode and energy consumer, INC is prohibited;
ii) forward mode and energy generator, DEC is prohibited;
iii) reverse mode and energy consumer, DEC is prohibited;
iv) reverse mode and energy generator, INC is prohibited.
   Stated otherwise, the control torque setpoint Ccons is prohibited from continuing to increase, whatever the increase in the requested-torque setpoint C CAN so as not to tend to increase the consumption of current Idc and therefore yet further “load” the Proportional Integral regulator 92 and peak limiter 93 assembly which, any way, will not be able to permit a torque setpoint Ccons greater than that reached when that the said Proportional Integral regulator 92 and peak limiter 93 assembly has entered into operation. On the other hand, the control torque setpoint Ccons is permitted to decrease.

In conclusion, let us indicate that the invention also makes it possible to perform checks of proper operation of the inverter-motor system. Indeed, checks of coherence of power consumed (or generated) can be performed between the input of the inverter on supply line 20 and the output of the inverter 1 on the phases U, V, W of the motor 6. Moreover, the current sensor 21 makes it possible to calculate in real time the efficiency of the inverter 1. Furthermore, the invention makes it possible to carry out coherence checks. For example, if the resolver 60 of the motor 6 accidentally shifts, the current-servocontrol of the motor will operate normally but the stator magnetic field will not be correctly phased with respect to the rotor. The torque actually produced will be lower than the setpoint torque. Let us stress the this coherence check is possible even if the torque is not measured. The mechanical power output by the motor 6 equals the product of the mechanical torque and the rotation speed. The electrical power consumed at the input of the inverter must correspond to the mechanical power plus the losses. By virtue of the measurement of the voltage and of the current of the supply line 20, this electrical power is known and makes it possible to estimate a mechanical power (by deducting a plausible value of losses), thereby making it possible to estimate the mechanical torque at the output shaft of the motor. It is then possible to compare this mechanical torque with the torque setpoint. A deviation beyond an experimental threshold makes it possible to activate an alert, and it is possible to propose as an aid to fault repair the possible causes, namely a defect of the resolver 60 or of a phase current sensor or that of the DC bus, the DC bus voltage measurement, etc.

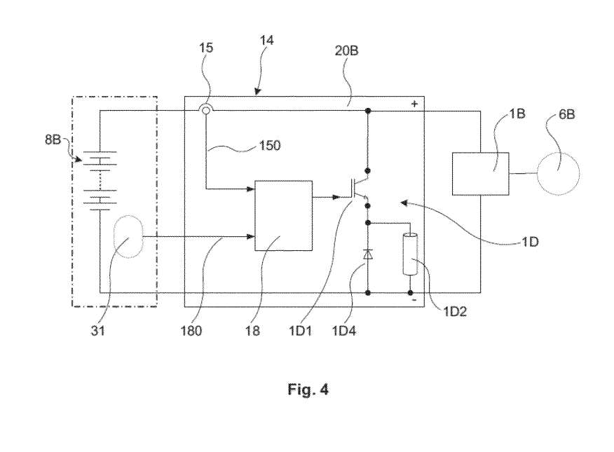

Seen in FIG. 4 is a device for managing the electrical power under braking 14 connected on the one hand to an inverter 1B supplying an electric traction machine 6B of a vehicle and on the other hand to an electrical energy storage battery 8B. The battery 8B comprises a battery management system 31. The device for managing the electrical power under braking 14 comprises a DC bus 20B whose positive line + and negative line − may be seen. The device for managing the electrical power under braking 14 comprises a dissipation branch 1D connected to the positive line + to and the negative line −. This dissipation branch 1D comprises a dissipation electronic breaker 1D1, consisting for example of a transistor, connected in series with a dissipation resistor 1D2. Also seen is a diode 1D4 which, upon the opening of the dissipation electronic breaker 1D1, allows the current which was flowing in the dissipation resistor 1D2 to vanish. This is all the more useful as this circuit is inductive. The device for managing the electrical power under braking 14 comprises a current sensor 15 on the DC bus 20B.

The controller 1B is entirely comparable with the controller 1 of the previous example. Its description is not repeated and the drawing of FIG. 5 is simplified. The current sensor 15 is represented in FIG. 4 could be that integrated into the inverter 1B, and conversely the inverter could use the information item originating from an exterior sensor such as the current sensor 15. The object of the example described with the backing of FIG. 4 is to describe an application of the invention to a “source” comprising elements of two different technologies: a battery 8B and a dissipation resistor 1D2.

A controller 18 ensures the control of the device for managing the electrical power under braking 14. It is seen that it receives from the battery management system 31, via a CAN® bus 180, various items of information useful for the management of the braking power, including a “limit current for recharging the battery” setpoint Ic_recharge_max, a measurement of the current on the DC bus 20B, delivered by the sensor of the current 15 via a line 150. The controller 18 comprises a comparator evaluating the difference between the battery recharging limit current and the current on the DC bus, the controller comprising a unit ensuring the control of the dissipation electronic breaker according to a cycle maintaining the battery charge current equal to the battery recharging limit current when the current on the DC bus is not less than the battery recharging limit current.

Thus, the control of the dissipation power, that is to say the share of the of the power produced by the electric machine 21 which cannot be used to charge the battery 30, is done through an appropriate duty ratio of opening and closing of the dissipation electronic breaker 1D1; the time during which the dissipation electronic breaker 1D1 is open varies as a function of the deviation between the setpoint of maximum battery charge current and the measurement of the current by the current sensor 15.

In this example, the controller integrated into the inverter makes it possible to control the phase currents of the electric motor as a function of the requested-torque setpoint and while maintaining the current passing through the supply line 20B at a value compatible with the limits of the source, the latter being considered globally, namely formed the battery 8B and the dissipation resistor 1D2.

In summary, let us stress that the present invention makes it possible to check the current tapped off (or injected) by the inverter on the electrical energy source by virtue of a regulator acting on a magnitude which is influential of the power consumed. It entails acting on the motor torque so as to decrease the power tapped off (or injected) at the inverter input and consequently to decrease the current consumed. Whatever the type of motor, the inverter integrates a motor control loop charged with servocontrolling a torque internal setpoint. On the basis of a torque setpoint coming from outside the inverter (action of the driver of the vehicle, optionally via a vehicle supervisor), and by measuring a current tapped off (in traction mode) or injected (under recuperative braking) on the electrical energy source, of consumption to be complied with, the present invention makes it possible to adapt the effective setpoint of motor torque so as to comply with a maximum current allowable by the electrical energy source. Although the invention has been described while referring to a synchronous motor, to a resolver, it may also be applied to the control of an asynchronous motor; it can also apply to the control of a synchronous motor without resorting to a sensor of relative position of the rotor with respect to the stator (resolver); it may also be applied with or without measurement of the supply voltage, while applying the invention's essential elements recalled hereinabove. Ultimately, by virtue of a measurement of the inverter supply current and by virtue of a regulator acting on a magnitude which is indicative of the power consumed (or injected) on the source, the inverter allows excellent, very fine, very reactive command of the current on the electrical supply line.

1-9. (canceled)

10. An installation comprising:
an electrical energy source that includes at least two elements of different technologies; and
an inverter for controlling an AC electric motor that includes a stator having at least two phases and a rotor, wherein the inverter includes:
two attachment terminals that attach to a DC bus associated with a DC electric voltage and the electrical energy source,
an AC current generator that delivers a current to a terminal strip, the terminal strip being connectable to the at least two phases of the AC electric motor,
a supply line positioned between the attachment terminals and the AC current generator,
a supply current measurement line on which flows a measurement of a supply current on the supply line,
at least one motor current measurement line, on each of which flows a measurement of an AC current on a respective one of the at least two phases of the AC electric motor, to enable the AC currents flowing in the at least two phases to be ascertained,
an input that receives information including at least values of limit currents of the electrical energy source for the supply current flowing on the supply line, the limit currents of the electrical energy source taking into consideration the at least two elements of different technologies, and including a requested-torque setpoint, and
a controller that receives the measurement of the supply current on the supply line, the measurements of the AC currents of the at least two phases of the AC electric motor, the limit currents of the electrical energy source, and the requested-torque setpoint,
wherein the controller controls phase currents of the AC electric motor as a function of the requested-torque setpoint while maintaining a current passing through the supply line at a value compatible with the values of the limit currents of the electrical energy source.

11. The installation according to claim 10, wherein the electrical energy source includes an electrical accumulator and a dissipation resistor.

12. The installation according to claim 10,
wherein the inverter ensures control of a synchronous motor, with the rotor being associated with a resolver that gives a relative position between the rotor and the stator, the inverter further including:
a supply voltage measurement line on which flows a measurement of a supply voltage on the supply line,
a second input that receives a signal from the resolver, wherein, to ensure control of the phase currents of the AC electric motor, the controller:
receives the measurement of the supply voltage on the supply line and the signal from the resolver, and
determines a control torque of the AC electric motor so as to control the phase currents of the AC electric motor in such a way that the control torque is identical to the requested-torque setpoint as long as the supply current on the supply line is different from the limit currents of the electrical energy source, and, when the supply current on the supply line reaches a limit current of the electrical energy source, the control torque is reduced with respect to the requested-torque setpoint so as not to exceed the limit current of the electrical energy source on the supply line.

13. The installation according to claim 12, wherein the inverter includes:
a current sensor that senses a current on the supply line, the current sensor delivering a measurement on the supply current measurement line,
a voltage sensor that senses a voltage on the supply line, the voltage sensor delivering a measurement on the supply voltage measurement line,
two AC current sensors that sense AC currents on certain phases supplying the AC electric motor, the two AC current sensors delivering measurements on two of the at least one motor current measurement line.

14. The installation according to claim 10, wherein the inverter includes a control stage that receives control orders from the controller and ensures control of power transistors of the AC current generator.

15. The installation according to claim 10, wherein the limit currents of the electrical energy source include:
a maximum-current setpoint of positive sign corresponding to a current tapped off from the electrical energy source when the AC electric motor is operating in a traction mode, and
a minimum-current setpoint of negative sign corresponding to a current returned to the electrical energy source when the AC electric motor is operating in a recuperative braking mode.

16. The installation according to claim 15, wherein the controller of the inverter includes:
a first processing line that receives the maximum-current setpoint,
a second processing line that receives the minimum-current setpoint, and
a module that enables toggling to and from the first and second processing lines according to a sign of the current of the AC electric motor.

17. The onstallation according to claim 10, wherein the controller of the inverter includes a torque ramp block that receives as input a requested-torque setpoint and that delivers a reprocessed control torque setpoint.

18. The installation according to claim 10, wherein the installation is utilized with in an electric motor used for traction of an electric vehicle.
